(19) United States
(12) Patent Application Publication
(10) Pub. No.: US 2015/0196999 A1
(43) Pub. Date: Jul. 16, 2015

(54) STRAINER REMOVAL TOOL FOR A LIQUID CONTAINER

(71) Applicant: Caterpillar Inc., Peoria, IL (US)

(72) Inventors: Rajesh Sampath, Chennai (IN); Sivanesaselvam Thangarajan, Chennai (IN)

(73) Assignee: Caterpillar Inc., Peoria, IL (US)

(21) Appl. No.: 14/667,735

(22) Filed: Mar. 25, 2015

(51) Int. Cl. B25B 27/20

(52) U.S. Cl. CPC B25B 27/205

(57) ABSTRACT

A strainer removal tool for the removal of a strainer is provided. The strainer removal tool includes a first member with a first handle portion and a first jaw portion. The strainer removal tool further includes a second member with a second handle portion and a second jaw portion. The first jaw portion and the second jaw portion include tip portions with a tooth portion, a recessed portion, and a clamp profile. The tooth portion is positioned radially inward to engage the locking tab of the strainer. The recessed portion of the tip portion includes a cut-out portion to receive the perimeter portion of the locking tab of the strainer. The clamp profile has a radial portion, which overlays the perimeter portion of the locking tab. The first member is pivotably attached to the second member between the handle portions and the jaw portions.

### TECHNICAL FIELD

The present disclosure generally relates to the use of hand-held removal tools in removing strainers. More particularly, the present disclosure relates to a strainer removal tool for the removal of a strainer from a fill neck of a liquid container.

### BACKGROUND

As it relates to the operation of low-emission regulated engines, an aftertreatment system is associated with treating the exhaust of an engine system. The aftertreatment system is configured to treat and reduce nitrogen oxides (NOx) and/or other unfavorable compounds present in an exhaust gas flow. In order to reduce NOx, the aftertreatment system may include a selective catalytic reduction (SCR) system having a reductant delivery module. The reductant delivery module may include a tank to store a reductant. The reductant from the tank may be delivered to a reductant injector via a pump and reductant delivery lines.

In existing SCR systems, it is typical for the tank of the reductant delivery module to include a debris removal device between the tank and the pump, such as a filter element. The filter element is generally used to remove particulate matter from the liquid to avoid contamination of the liquid reductant. Such filter element may be specialized, expensive and difficult to service and clean, resulting in engine shutdown. Over a period of time, the filter element becomes clogged with particulate contamination from the reductant that is pumped into the tank. Hence, the filter elements may require frequent service. The filter elements may be hard to access and difficult to disconnect, which makes removal of the filter elements from the tanks cumbersome and time consuming Moreover, the reductant is generally a liquid which an operator does not want to touch, get on clothes or spill on the ground. Therefore, care must be taken to remove for service and install the new or cleaned filter element after the service.

U.S. Pat. No. 3,495,320 discloses an apparatus to grip filter cartridges and unseat them. The apparatus includes arcuate-shaped jaw portions to provide inward pressure in an attempt to hold the filter cartridge for removal. However such filter cartridge may still be prone to movement relative to the jaw portions and slippage of the filter cartridge is likely as it is being removed.

### SUMMARY OF THE INVENTION

Various aspects of the present disclosure describe a strainer removal tool for removal of a strainer from a fill neck of a liquid container. The strainer is engaged with the fill neck of the liquid container via at least one locking tab. The at least one locking tab has a perimeter portion and a neck portion. The at least one locking tab is movable in a radial direction, which unlocks the strainer from the fill neck. This facilitates simultaneous selective ejection of the strainer by longitudinal movement of the strainer, via depression of the locking tab of the strainer. The strainer removal tool includes a first member and a second member. The first member has a first handle portion and a first jaw portion. Similarly, the second member includes a second handle portion and a second jaw portion. Each of the first jaw portion and the second jaw portion includes tip portions. Each tip portion includes a tooth portion, a recessed portion and a clamp profile. The tooth portion is positioned radially inward to engage the locking tab of the strainer. The recessed portion of the tip portion includes a cut-out portion to receive the perimeter portion of the locking tab of the strainer. The clamp profile has a radial portion, which overlays the perimeter portion of the locking tab. The first member is pivotably attached to the second member between the handle portions and the jaw portions. The first jaw portion and the second jaw portion are moveable radially inwards towards each other, in response to selective movement of the handle portions of the first member and second member.

### BRIEF DESCRIPTION OF THE DRAWINGS

FIG. 1 is a side view of a liquid container with a strainer locked within a fill neck and a strainer removal tool, in accordance with the concepts of the present disclosure;

FIG. 2 is an enlarged perspective view of the strainer of FIG. 1, in accordance with the concepts of the present disclosure;

FIG. 3 is a perspective view of the strainer removal tool of FIG. 1, in accordance with the concepts of the present disclosure;

FIG. 4 is a cross-sectional view of the strainer locked in the fill neck of the liquid container of FIG. 1, and an encircled portion shows the strainer removal tool in contact with the strainer to initiate removal of the strainer, in accordance with the concepts of the present disclosure;

FIG. 5 is an enlarged view of the encircled portion of FIG. 4, in accordance with the concepts of the present disclosure; and

FIG. 6 is a cross-sectional view of the strainer in the fill neck of the liquid container of FIG. 1, and the strainer removal tool is shown completely depressing locking tabs of the strainer and the strainer is displaced from its locked position for removal from the fill neck by the strainer removal tool, in accordance with the concepts of the present disclosure.

### DETAILED DESCRIPTION

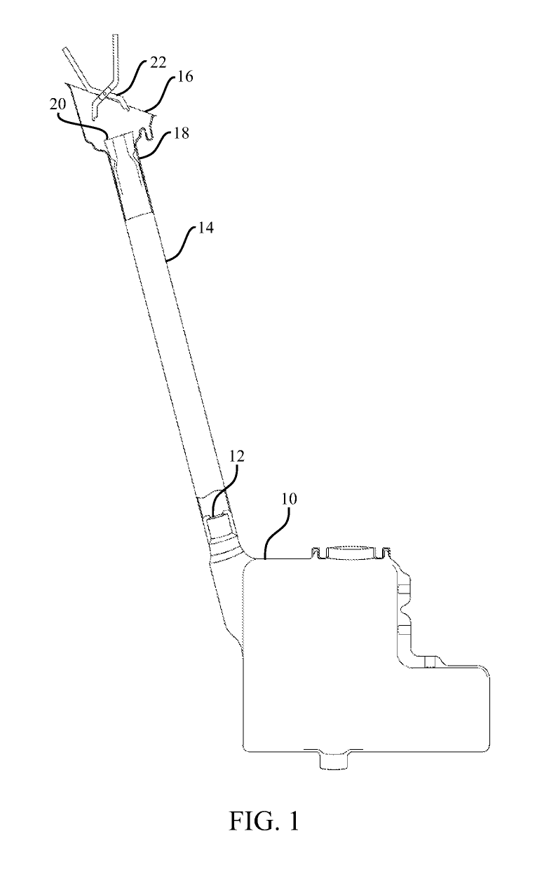

Referring to FIG. 1, there is shown a liquid container 10. The liquid container 10 may be used to store a reductant that is widely used in selective catalytic reduction systems. The liquid container 10 includes a vent 12 that is connected to a fill neck 14. The fill neck 14 acts as a remote connection hose that facilitates delivery of the reductant to the liquid container 10, via the vent 12. In the illustrated embodiment, the liquid container 10 is a remote connection tank. The fill neck 14 is connected to a flange connector 16. The flange connector 16 is generally secured onto a machine (not shown) via fastening elements known in the art. The flange connector 16 includes a fill cap (not shown) which covers the fill neck 14 to protect the reductant from contamination during fueling of the liquid container 10. Below the filler cap (not shown), the fill neck 14 includes an accommodating portion 18 that accommodates a strainer 20. Further, there is shown a strainer removal tool 22, which is shown in a disengaged position with the strainer 20. The strainer removal tool 22 is used to remove the strainer 20 from the fill neck 14 of the liquid container 10.

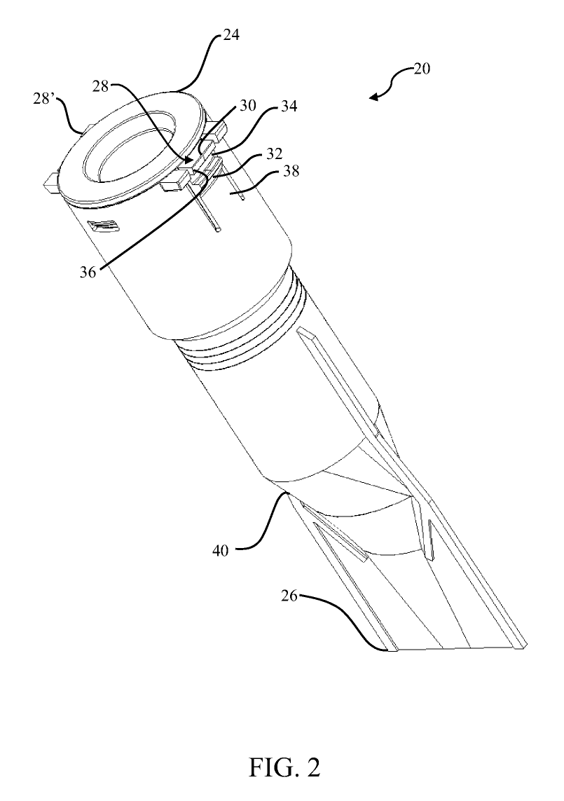

Referring to FIG. 2, there is shown the strainer 20. The strainer 20 is positioned in the fill neck 14 of the liquid container 10. The strainer 20 includes a first end 24 and a second end 26. The first end 24 is nearly circular in cross-section and is proximal to the fill cap (not shown). From the first end 24, the strainer 20 flattens in an axial direction to define a variation in cross-section at the second end 26. The strainer 20 is engaged with the fill neck 14 of the liquid container 10 by two locking tabs 28, 28′. A variation to the number of locking tabs 28, 28′ may be contemplated. The locking tabs 28, 28′ are positioned at an outer surface of a circular periphery of the first end 24, such that the locking tabs 28, 28′ are disposed diametrically opposite to each other. The locking tabs 28, 28′ include first wing portions 30, 30′ and second wing portions 32, 32′. The second wing portions 32, 32′ are positioned below the first wing portions 30, 30′ (in the direction of the second end 26), and is spaced apart by a recess cavity 34. The first wing portions 30, 30′ include perimeter portions 36, 36′. The second wing portions 32, 32′ are attached with neck portions 38, 38′. The first wing portions 30, 30′ and the second wing portions 32, 32′ are movable in a radial direction. Further, between the first end 24 and the second end 26, a passage 40 is defined to facilitate a flow of the reductant, which is supplied via the fill neck 14.

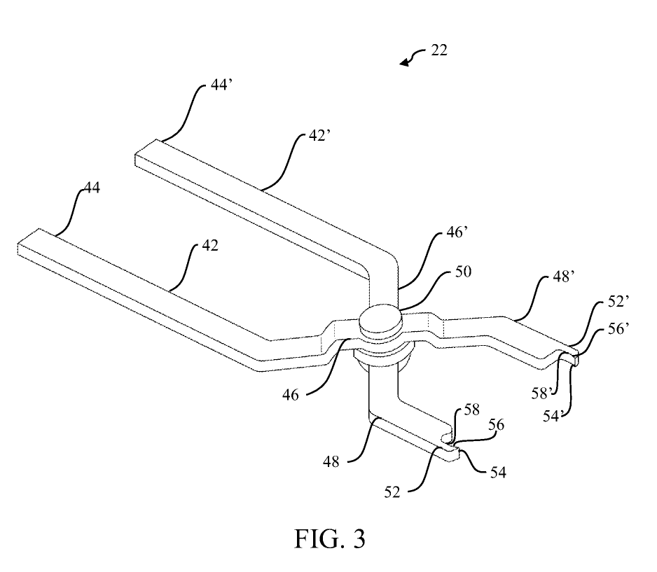

Referring to FIG. 3, there is shown a stand-alone strainer removal tool 22. The strainer removal tool 22 includes a first member 42 and a second member 42′. The first member 42 includes a first handle portion 44, a first pivot portion 46, and a first jaw portion 48. The first handle portion 44 and the first jaw portion 48 are connected to the first pivot portion 46. The first handle portion 44 and the first jaw portion 48 are oriented at an obtuse angle with respect to the first pivot portion 46. Similarly, the second member 42′ includes a second handle portion 44′, a second pivot portion 46′, and a second jaw portion 48′. The second handle portion 44′ and the second jaw portion 48′ are connected to the second pivot portion 46′. The second handle portion 44′ and the second jaw portion 48′ are oriented at an obtuse angle with respect to the second pivot portion 46′. The pivot portions 46, 46′ are connected by means of a rivet 50. The rivet 50 is in a position that is offset from a center of the pivot portions 46, 46′. This provides a pivotal relationship of the first jaw portion 48 and the second jaw portion 48′ relative to one another to secure the strainer 20. It may be envisioned that the pivot portions 46, 46′ may be connected by means of other suitable means at the centers.

The first jaw portion 48 and the second jaw portion 48′ both include tip portions 52, 52′. The tip portions 52, 52′ include tooth portions 54, 54′, clamp profiles 56, 56′, and recessed portions 58, 58′. The tooth portions 54, 54′ are structured to be positioned radially inward to engage the locking tabs 28, 28′ of the strainer 20. The tooth portions 54, 54′ are connected to the clamp profiles 56, 56′, each of which has a radial portion that overlays the perimeter portions 36, 36′ of the locking tabs 28, 28′. The clamp profiles 56, 56′ are connected to the recessed portions 58, 58′, which have cut-out portions such that the recessed portions 58, 58′ mate with the perimeter portions 36, 36′. In response to selective movement of the first handle portion 44 and the second handle portion 44′, the first jaw portion 48 and the second jaw portion 48′ move towards each other.

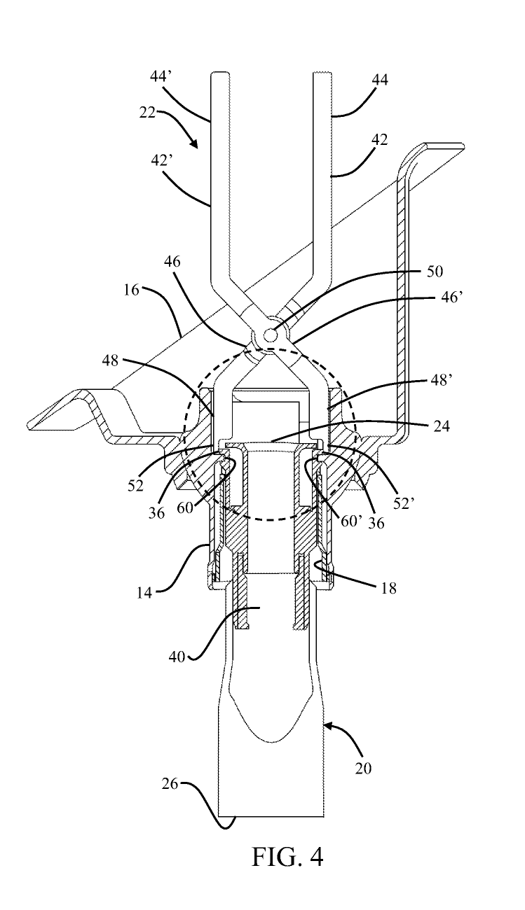

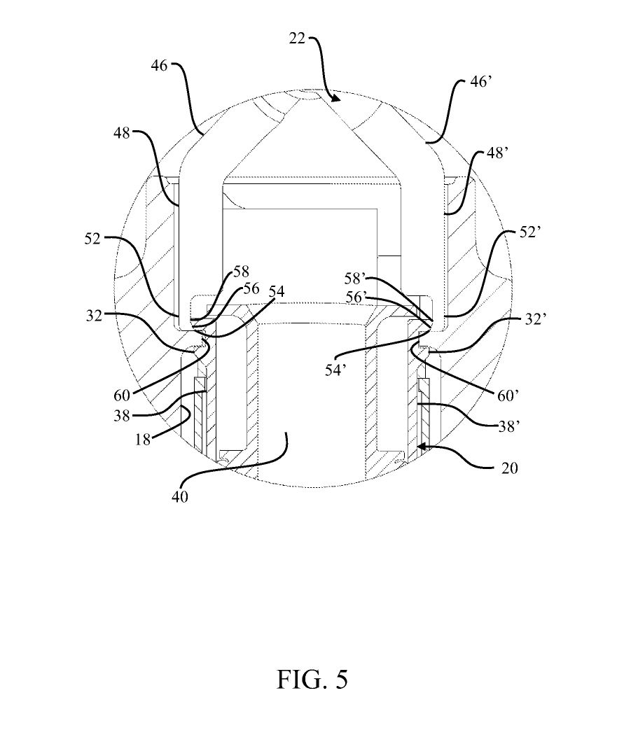

Referring to FIG. 4, there is shown a sectional view of the flange connector 16 along with the strainer 20 and the strainer removal tool 22. The engagement of the strainer 20 with the fill neck 14 and the strainer removal tool 22 is shown by an encircled portion. The encircled portion is shown in an enlarged view in FIG. 5. The strainer 20 is pushed in along the axial direction for positioning the strainer 20 in the fill neck 14. During the positioning process, the second wing portions 32, 32′ of the locking tabs 28, 28′, are pushed against retention fins 60, 60′ of the accommodating portion 18 in the fill neck 14. Due to force applied on the second wing portions 32, 32′, the locking tabs 28, 28′ are pushed inwards. This results in fit engagement of the retention fins 60, 60′ of the fill neck 14 in the recess cavity 34 of the locking tabs 28, 28′, thereby resulting in retention of the strainer 20 in the fill neck 14. Further, the strainer removal tool 22 manipulates the first wing portions 30, 30′ and the second wing portions 32, 32′ to unlock the strainer 20 from the fill neck 14, for selective ejection of the strainer 20. When depressed, the selective ejection of the strainer 20 is achieved by longitudinal movement of the strainer 20 with the locking tabs 28, 28′ of the strainer 20.

In addition, as shown in FIG. 4 and FIG. 5, the strainer removal tool 22 is shown in an engagement with the strainer 20. The engagement is made to achieve removal of the strainer 20. For optimum engagement during a removal process, the tooth portions 54, 54′ of the strainer removal tool 22 are positioned radially inwards to engage the locking tabs 28, 28′ of the strainer 20. The recessed portions 58, 58′ receive the perimeter portions 36, 36′ of the first wing portions 30, 30′ of the locking tabs 28, 28′. The clamp profiles 56, 56′ overlay the perimeter portions 36, 36′ of the first wing portions 30, 30′.

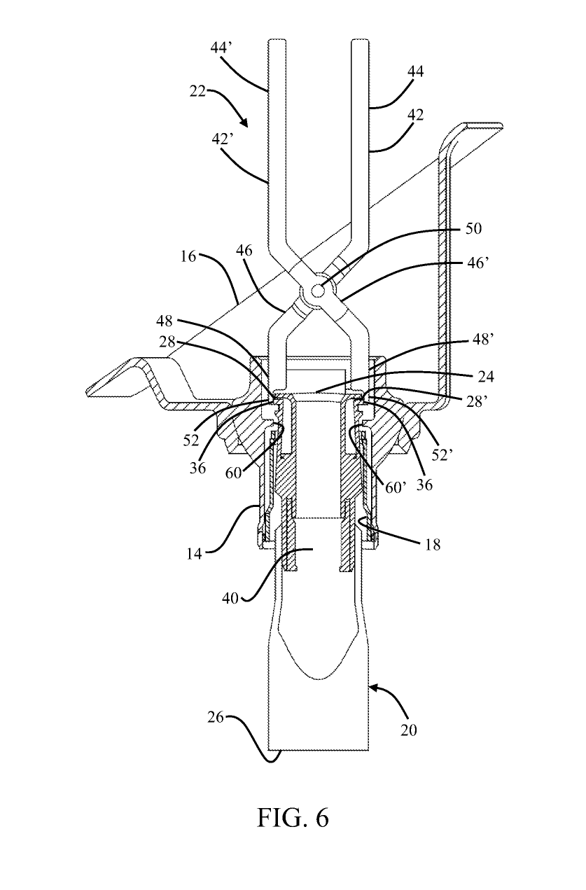

During the removal process, the tip portions 52, 52′ are squeezed by manipulation of the first handle portion 44 and the second handle portion 44′. As the tip portions 52, 52′ move close to each other, the tooth portions 54, 54′, the clamp profiles 56, 56′, and the recessed portions 58, 58′ depress the first wing portions 30, 30′ and the second wing portions 32, 32′ of the locking tabs 28, 28′. As shown in FIG. 6, the locking tabs 28, 28′ depress inward relative to the strainer 20, and the strainer 20 is pulled out by the strainer removal tool 22.

### INDUSTRIAL APPLICABILITY

In operation, the strainer removal tool 22 is inserted in the fill neck 14 and engages with the strainer 20. The tooth portions 54, 54′ are engaged with the first wing portions 30, 30′ of the locking tabs 28, 28′. This implies that the clamp profiles 56, 56′ overlay the perimeter portions 36, 36′ of the second wing portions 32, 32′. Due to the profile of the recessed portions 58, 58′, the perimeter portions 36, 36′ of the second wing portions 32, 32′ mate with the recessed portions 58, 58′. Upon securing all the above mentioned engagements, the first handle portion 44 and the second handle portion 44′ are manipulated in a way such that the first jaw portion 48 and the second jaw portion 48′ move towards each other and against the locking tabs 28, 28′, to attain a relatively tight engagement of the tip portions 52, 52′ with the locking tabs 28, 28′. This results in depression of the first wing portions 30, 30′ and the second wing portions 32, 32′ in a radially inward direction. Depression of the locking tabs 28, 28′ leads to disengagement of the locking tabs 28, 28′ with the retention fins 60, 60′ of the fill neck 14. Upon disengagement of the locking tabs 28, 28′, the strainer removal tool 22 pulls out the strainer 20 from the fill neck 14.

The disclosed strainer removal tool 22 is equipped with the tip portions 52, 52′ structured to engage with the locking tabs 28, 28′ of the strainer 20. The tip portions 52, 52′, hence, efficiently mate with the first wing portions 30, 30′ of the locking tabs 28, 28′. This prevents damage to the locking tabs 28, 28′ of the strainer 20. The strainer removal tool 22 is convenient to use and facilitates efficient removal of the strainer 20.

The many features and advantages of the disclosure are apparent from the detailed specification, and thus, are intended by the appended claims to cover all such features and advantages of the disclosure that fall within the true spirit and scope thereof. Further, since numerous modifications and variations will readily occur to those skilled in the art, it is not desired to limit the disclosure to the exact construction and operation illustrated and described herein. Accordingly, all suitable modifications and equivalents may be resorted to that fall within the scope of the disclosure.

What is claimed is:

1. A strainer removal tool for removing a strainer from a fill neck of a liquid container, the strainer being engaged through at least one locking tab with the fill neck of the liquid container, the locking tab having a perimeter portion and a neck portion, the locking tab being movable in a radial direction to unlock the strainer from the fill neck in preparation for selective ejection of the strainer by longitudinal movement of the strainer contemporaneously with the locking tab of the strainer being depressed, the strainer removal tool comprising:
a first member having a first handle portion and a first jaw portion;
a second member having a second handle portion and a second jaw portion;
wherein the first jaw portion and the second jaw portion include tip portions, each tip portion includes; a tooth portion, a recessed portion and a clamp profile, the tooth portion being positioned radially inward to engage the locking tab of the strainer, the recessed portion of the tip portion having a cut-out portion to receive the perimeter portion of the locking tab of the strainer and the clamp profile which has a radial portion which overlays the perimeter portion of the locking tab;
wherein the first member being pivotably attached with the second member between the handle portions and the jaw portions thereof, the first jaw portion and the second jaw portion being moveable radially inwards towards each other in response to selective movement of the handle portions of the first member and the second member.
